(19) United States
(12) Patent Application Publication
(10) Pub. No.: US 2026/0117355 A1
(43) Pub. Date: Apr. 30, 2026

(54) Amorphous Alloy Soft Magnetic Powder, Dust Core, Magnetic Element, And Electronic Device

(71) Applicant: SEIKO EPSON CORPORATION, Tokyo (JP)

(72) Inventors: Kohei KASAI, Hachinohe (JP); Mayu WATANABE, Hachinohe (JP); Shiho KAWAHARA, Hachinohe (JP)

(21) Appl. No.: 19/374,366

(22) Filed: Oct. 30, 2025

(30) Foreign Application Priority Data
Oct. 31, 2024 (JP) 2024-191448

(51) Int. Cl. C22C 45/02; B22F 1/05; B22F 1/0655; B22F 1/142; B22F 1/148; B22F 9/08; B22F 9/10; H01F 1/38; H01F 27/255

(52) U.S. Cl. CPC C22C 45/02; B22F 1/05; B22F 1/0655; B22F 1/142; B22F 1/148; B22F 9/082; B22F 9/10; H01F 1/38; B22F 2009/0828; B22F 2201/02; B22F 2301/35; B22F 2304/10; B22F 2998/10; B22F 2999/00; C22C 2200/02; C22C 2202/02; H01F 27/255

(57) ABSTRACT

An amorphous alloy soft magnetic powder includes: impurities; and a composition represented by a composition formula Feₐ(Si₁₋ₓBₓ)_{b}C_{c}S_{d} represented by an atomic ratio, where a is 100−b−c−d. In addition, b, c, d, and x are 16.0≤b≤22.0, 0<c≤4.0, 0.001≤d≤0.080, and 0.5≤x≤0.9. In a volume-based cumulative particle size distribution obtained using a laser diffraction type particle size distribution measurement device, when D50 is a particle diameter at which a cumulative frequency is 50% from a small diameter side, the particle diameter D50 is 22.0 μm or more and 32.0 μm or less, hollow particles are contained, and a number ratio of the hollow particles is 3% or more and 22% or less.

The present application is based on, and claims priority from JP Application Serial Number 2024-191448, filed Oct. 31, 2024, the disclosure of which is hereby incorporated by reference herein in its entirety.

### BACKGROUND

### 1. Technical Field

The present disclosure relates to an amorphous alloy soft magnetic powder, a dust core, a magnetic element, and an electronic device.

### 2. Related Art

JP-A-2020-155637 discloses a soft magnetic powder including particles having pores therein and a magnetic core including the soft magnetic powder. In the soft magnetic powder, when a volume filling rate of the soft magnetic powder in the magnetic core is η%, the number of pores present in a region of 2.5 mm square in any cross section of the magnetic core satisfies a range of 60×(η/80) or more and 10000×(η/80) or less. According to such a configuration, since the number of pores is within the above range, a magnetic core having both high permeability and good DC superimposition characteristics can be obtained. In addition, in JP-A-2020-155637, an Fe—B—Si—Cr—C-based alloy is exemplified as a composition of an Fe-based alloy including amorphous material.

JP-A-2020-155637 is an example of the related art.

However, in the soft magnetic powder containing the amorphous Fe-based alloy described above, a shape of a particle may be disturbed due to the formation of pores in the particle. In this case, since filling properties of the particles decrease, there is a concern that a density of the magnetic core decreases. As a result, the permeability of the magnetic core cannot be sufficiently enhanced. In addition, the soft magnetic powder described above has room for investigation also in reduction of iron loss.

Therefore, there is a demand for an amorphous alloy soft magnetic powder capable of producing a magnetic element having low iron loss, high density, and good DC superimposition characteristics.

### SUMMARY

An amorphous alloy soft magnetic powder according to an application example of the present disclosure includes:
impurities; and
a composition represented by a composition formula Feₐ(Si₁₋ₓBₓ)_{b}C_{c}S_{d} represented by an atomic ratio, where a is 100−b−c−d, and b, c, d, and x are 16.0≤b≤22.0, 0<c≤4.0, 0.001≤d≤0.080, and 0.5≤x≤0.9,
in a volume-based cumulative particle size distribution obtained using a laser diffraction type particle size distribution measurement device, when D50 is a particle diameter at which a cumulative frequency is 50% from a small diameter side, the particle diameter D50 is 22.0 μm or more and 32.0 μm or less,
hollow particles are contained, and
a number ratio of the hollow particles is 3% or more and 22% or less.

A dust core according to an application example of the present disclosure includes:
the amorphous alloy soft magnetic powder according to the application example of the present disclosure.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a longitudinal cross-sectional view showing an example of a device for producing an amorphous alloy soft magnetic powder by a rotary water jet atomization method.

FIG. 2 is a plan view schematically showing a toroidal type coil component.

FIG. 3 is a transparent perspective view schematically showing a closed magnetic circuit type coil component.

FIG. 4 is a perspective view showing a mobile personal computer which is an electronic device according to an embodiment.

FIG. 5 is a plan view showing a smartphone which is the electronic device according to the embodiment.

FIG. 6 is a perspective view showing a digital still camera which is the electronic device according to the embodiment.

FIG. 7 is Table 1 showing the composition and the like of the amorphous alloy soft magnetic powders of sample Nos. 1 to 9.

FIG. 8 is Table 2 showing the composition and the like of the amorphous alloy soft magnetic powders of sample Nos. 10 to 17.

FIG. 9 is Table 3 showing evaluation results and the like of the amorphous alloy soft magnetic powders of sample Nos. 1 to 9.

FIG. 10 is Table 4 showing the evaluation results and the like of the amorphous alloy soft magnetic powders of sample Nos. 10 to 17.

### DESCRIPTION OF EMBODIMENTS

Hereinafter, an amorphous alloy soft magnetic powder, a dust core, a magnetic element, and an electronic device according to the present disclosure will be described in detail based on a preferred embodiment shown in the accompanying drawings.

### 1. Amorphous Alloy Soft Magnetic Powder

An amorphous alloy soft magnetic powder according to an embodiment is a metal powder exhibiting soft magnetism. The amorphous alloy soft magnetic powder can be applied to various uses, for example, production of various green compacts such as a dust core and an electromagnetic wave absorber by binding particles together with a binder.

The amorphous alloy soft magnetic powder according to the embodiment is formed of impurities and a composition represented by a composition formula Feₐ(Si₁₋ₓBₓ)_{b}C_{c}S_{d} represented by atomic ratio, where a is 100−b−c−d, and b, c, d, and x are 16.0≤b≤22.0, 0<c≤4.0, 0.001≤d≤0.080, and 0.5≤x≤0.9.

In addition, in the amorphous alloy soft magnetic powder according to the embodiment, in a volume-based cumulative particle size distribution acquired using a laser diffraction type particle size distribution measurement device, when a particle diameter at which the cumulative frequency is 50% from the small diameter side is defined as D50, the particle diameter D50 is 22.0 μm or more and 32.0 μm or less.

Further, the amorphous alloy soft magnetic powder according to the embodiment contains hollow particles, and a number ratio of the hollow particles is 3% or more and 22% or less. The number ratio of the hollow particles refers to a ratio of the number of hollow particles to the number of particles provided in an obtained observation image when a cross section of the amorphous alloy soft magnetic powder is observed.

Since such an amorphous alloy soft magnetic powder contains an optimum amount of S (sulfur), the amorphous alloy soft magnetic powder contains hollow particles and has an optimized outer shape and particle size distribution. Accordingly, it is possible to reduce an eddy current loss due to the hollow particles and prevent a decrease rate of the permeability due to a DC bias current, and to enhance the fluidity and the filling properties due to the outer shape and the particle size distribution. As a result, it is possible to implement an amorphous alloy soft magnetic powder capable of producing a dust core having low iron loss, high density, and good DC superimposition characteristics.

Hereinafter, the amorphous alloy soft magnetic powder according to the embodiment will be described in detail.

### 1.1. Composition

Hereinafter, a composition of the amorphous alloy soft magnetic powder will be described in detail. As described above, the amorphous alloy soft magnetic powder according to the embodiment has a composition represented by a composition formula Feₐ(Si₁₋ₓBₓ)_{b}C_{c}S_{d}. The composition formula represents an atomic ratio in a composition containing five elements of Fe, Si, B, C, and S.

Fe (iron) greatly affects basic magnetic properties and mechanical properties of the amorphous alloy soft magnetic powder according to the embodiment.

A content of Fe is not particularly limited, and is set such that Fe is a main component, that is, the atomic ratio is the highest in the amorphous alloy soft magnetic powder.

a represents a ratio of Fe in terms of the number of atoms, and is preferably 76.0≤a≤81.0, more preferably 77.0≤a≤80.7, and further preferably 78.0≤a≤80.5. When a is less than the lower limit value, the magnetic properties or corrosion resistance may deteriorate. On the other hand, when a is more than the upper limit value, the amorphous alloy soft magnetic powder is likely to be crystallized during production.

When the amorphous alloy soft magnetic powder is produced from a raw material, Si (silicon) promotes amorphization and enhances permeability of the amorphous alloy soft magnetic powder. Accordingly, high permeability and low coercive force can be achieved.

B (boron) promotes the amorphization when the amorphous alloy soft magnetic powder is produced from a raw material. In particular, by using Si and B in combination, the amorphization can be synergistically promoted based on a difference in an atomic radius between Si and B. Accordingly, high permeability and low coercive force can be sufficiently achieved.

x represents a ratio of the number of B atoms to the total number of atoms when the total of the number of Si atoms and the number of B atoms is 1. In the amorphous alloy soft magnetic powder according to the embodiment, x is 0.5≤x≤0.9, and preferably 0.6≤x≤0.8. Accordingly, a balance between the number of Si atoms and the number of B atoms can be optimized. When x is less than the lower limit value or more than the upper limit value, the balance between the number of Si atoms and the number of B atoms is lost, making it difficult to achieve the amorphization, for example, when attempting to enhance the magnetic properties by enhancing the ratio of Fe.

b represents a total ratio of Si and B, and is 16.0≤b≤22.0, preferably 17.0≤b≤21.0, and more preferably 18.0≤b≤20.0. When b is less than the lower limit value or more than the upper limit value, the amorphous alloy soft magnetic powder is likely to be crystallized during production.

A content of Si is preferably 3.0 atomic % or more and 8.0 atomic % or less, and more preferably 5.0 atomic % or more and 7.0 atomic % or less.

A content of B is preferably 10.0 atomic % or more and 15.5 atomic % or less, and more preferably 12.5 atomic % or more and 14.5 atomic % or less.

C (Carbon) lowers the viscosity of a molten material when the raw material for the amorphous alloy soft magnetic powder is melted, facilitating amorphization and pulverization. Accordingly, an amorphous alloy soft magnetic powder having a small diameter and high permeability can be obtained. As a result, eddy current loss can be reduced even in a high frequency range.

c represents a content of C, which is 0<c≤4.0, preferably 1.0≤c≤3.5, and more preferably 1.5≤c≤2.5. When c is less than the lower limit value, the viscosity of the molten material does not sufficiently decrease, and a shape of the particles is irregular. Therefore, filling properties during compacting is reduced, and a saturation magnetic flux density and the permeability of a green compact cannot be sufficiently enhanced. On the other hand, when c is more than the upper limit value, the amorphous alloy soft magnetic powder is likely to be crystallized during production.

S (sulfur) reduces the viscosity of the molten material. Accordingly, the molten material is likely to entrain air, and hollow particles are likely to be formed. In addition, the outer shape of the particles tends to approach a spherical shape. Further, since S is a metalloid element and can enhance an amorphous forming ability, an amorphous alloy soft magnetic powder having sufficiently low crystallinity is obtained.

The hollow particles contribute to reduction in eddy current loss and reduction of a decrease rate in permeability due to a DC bias current. In addition, the outer shape contributes to improvement in fluidity and filling properties of the amorphous alloy soft magnetic powder. Further, a sufficient decrease in crystallinity contributes to the achievement of an amorphous alloy soft magnetic powder having both high permeability and low coercive force.

d represents a content of S and is 0.001≤d≤0.080, preferably 0.005≤d≤0.060, and more preferably 0.012≤d≤0.040. When d is less than the lower limit value, effects such as a decrease in crystallinity, formation of hollow particles, and promotion of spheroidization may not be sufficiently obtained. On the other hand, when d is more than the upper limit value, an addition amount is excessive, the crystallinity becomes high, the hollow particles become insufficient or excessive, and the spheroidization may be inhibited.

By optimizing a ratio d/c of d to c, the effects of promoting spheroidization and improving the amorphous forming ability are particularly remarkable. The ratio d/c is preferably 0.005 or more and 0.050 or less, more preferably 0.007 or more and 0.040 or less, and further preferably 0.008 or more and 0.030 or less. When the ratio d/c is less than the lower limit value, the ratio of d to c decreases, and when the ratio d/c is more than the upper limit value, the ratio of d to c is excessive, so that it may be difficult to further improve the effects such as the porosity (number ratio of hollow particles), the promotion of spheroidization, and the improvement of the amorphous forming ability.

The amorphous alloy soft magnetic powder according to the embodiment may contain impurities formed of other elements in addition to the elements as described above. A total content of the impurities is preferably 1.0 mass % or less, more preferably 0.2 mass % or less, and further preferably 0.1 mass % or less. In addition, the content of each element alone is preferably 0.2 mass % or less, more preferably 0.1 mass % or less, and further preferably 0.05 mass % or less. When the content is within the range, an effect of the present disclosure is less likely to be inhibited by the other elements, and the content is acceptable.

Although the composition of the amorphous alloy soft magnetic powder according to the embodiment is described in detail above, the composition and impurities described above are identified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge optical emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specific examples include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur (S), an infrared absorption method after combustion in a current of oxygen (combustion in high frequency induction furnace) defined in JIS G 1211:2011 is also used. Specifically, an example thereof is a carbon and sulfur analyzer CS-200 manufactured by LECO Corporation.

Further, when nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen and nitrogen analyzer, TC-300/EF-300, manufactured by LECO Corporation.

### 1.2. Various Properties

A state of the amorphous alloy in the amorphous alloy soft magnetic powder can be identified based on the crystallinity. The crystallinity of the amorphous alloy soft magnetic powder is calculated based on a spectrum obtained by X-ray diffraction of the amorphous alloy soft magnetic powder based on the following formula.

$$Crystallinity = \{ intensity derived from crystal / ( intensity derived from crystal + intensity derived from amorphous ) \} \times 100$$

As an X-ray diffraction device, for example, RINT2500V/PC manufactured by Rigaku Corporation is used.

The crystallinity measured by such a method is preferably 70% or less, more preferably 60% or less, and further preferably 40% or less. In other words, the amorphous alloy soft magnetic powder is preferably entirely amorphized, and may contain a crystalline structure at a volume ratio of, for example, 70% or less. Accordingly, in the amorphous alloy soft magnetic powder, soft magnetism derived from the amorphous alloy is stably exhibited. As a result, a sufficiently low coercive force is achieved, and an amorphous alloy soft magnetic powder having good DC superimposition characteristics is obtained.

In a volume-based cumulative particle size distribution of the amorphous alloy soft magnetic powder obtained using a laser diffraction type particle size distribution measurement device, D10 is a particle diameter at which the cumulative frequency is 10% from a small diameter side, D50 is a particle diameter at which the cumulative frequency is 50% from the small diameter side, and D90 is a particle diameter at which the cumulative frequency is 90% from the small diameter side.

The particle diameter D10 of the amorphous alloy soft magnetic powder is 5.0 μm or more and 14.0 μm or less, and preferably 9.0 μm or more and 12.0 μm or less. Such a particle diameter D10 can contribute to a relatively wide particle size distribution in consideration of a balance with the particle diameter D50. Therefore, it is possible to appropriately combine particles having a small particle diameter and particles having a large particle diameter, and thus it is possible to achieve good filling properties. Accordingly, it is possible to further increase the density of the dust core.

When the particle diameter D10 is less than the lower limit value, the number of small particles is relatively large, so that the number of secondary particles increases, and the filling properties during compacting cannot be sufficiently enhanced. On the other hand, when the particle diameter D10 is more than the above upper limit value, since the number of small particles is relatively small, gaps during filling increase, and the filling properties during compacting cannot be sufficiently enhanced.

The particle diameter D50 of the amorphous alloy soft magnetic powder is 22.0 μm or more and 32.0 μm or less, and preferably 24.0 μm or more and 30.0 μm or less. Such an amorphous alloy soft magnetic powder has a relatively large particle diameter, and thus has excellent fluidity, and thus can achieve good filling properties. Accordingly, it is possible to further increase the density of the dust core.

When the particle diameter D50 is less than the lower limit value, the particle diameter is too small, so that the fluidity decreases and the filling properties during compacting cannot be sufficiently enhanced. On the other hand, when the particle diameter D50 is more than the upper limit value, the particle diameter is too large, so that the amorphization is difficult and the eddy current loss in the magnetic element tends to increase.

In the amorphous alloy soft magnetic powder, the ratio of the particle diameter D10 to the particle diameter D90 is defined as a particle diameter ratio D10/D90. At this time, the particle diameter ratio D10/D90 is preferably 0.210 or more and 0.225 or less, and more preferably 0.210 or more and 0.220 or less. The particle diameter ratio D10/D90 is an indicator showing a degree of spread of particle size distribution, and by having the indicator within the above range, the filling properties of the amorphous alloy soft magnetic powder are particularly good.

The amorphous alloy soft magnetic powder contains hollow particles, and the number ratio of the hollow particles is 3% or more and 22% or less, preferably 5% or more and 16% or less, and more preferably 6% or more and 12% or less. The hollow particle refers to a particle having a space therein. The space may be a closed space or an open space communicating with the outside via an opening. Such hollow particles make it difficult for an eddy current to flow in the particles. Accordingly, the eddy current loss in the magnetic element can be reduced. In addition, the hollow particles slightly reduce a space factor of the amorphous alloy in the dust core, thereby reducing the decrease rate of the permeability due to the DC bias current. Accordingly, the DC superimposition characteristics of the magnetic element can be improved.

The number ratio of the hollow particles is measured as follows.

First, an amorphous alloy soft magnetic powder is embedded in a resin to prepare a test object. For example, an epoxy resin is used as the resin. After the resin is cured, the test object is polished to expose cross sections of the particles on a polished surface. Next, the polished surface is observed using a digital microscope to acquire an image. An imaging range is adjusted so that 100 to 300 particles appear in one image. When the number of particles captured in one image is less than 100, a plurality of images may be used. Next, the total number of particles and the number of hollow particles in the image are counted. The hollow particle is a particle having a hollow portion inside the surface of the particle in a particle image provided in the image. The number of hollow particles is counted by visually observing the image. The total number of particles may be visually counted or may be automatically counted using software. Examples of the software include Mac-View manufactured by Mountec Co., Ltd. Next, the number ratio of the number of hollow particles to the total number of particles is calculated.

A particle density of the amorphous alloy soft magnetic powder is preferably 7.05 g/cm³ or more and 7.18 g/cm³ or less, more preferably 7.07 g/cm³ or more and 7.16 g/cm³ or less, and further preferably 7.09 g/cm³ or more and 7.14 g/cm³ or less. When the particle density of the amorphous alloy soft magnetic powder is within the above range, a volume of the hollow portion in the hollow particle can be optimized. Accordingly, both low iron loss and high density and excellent DC superimposition characteristics can be achieved in the magnetic element.

The particle density of the amorphous alloy soft magnetic powder is measured using a dry automatic density meter, Accupic II 1340, manufactured by Shimadzu Techno Research Corporation. The device can measure particle density by a gas displacement method (constant volume expansion method).

An average circularity of the particles of the amorphous alloy soft magnetic powder is preferably 0.85 or more and less than 1.00, more preferably 0.86 or more and 0.98 or less, and further preferably 0.88 or more and 0.97 or less. Accordingly, even when the classified product is small-diameter particles, the particles are spheroidized, so that a filling state can be brought close to closest packing. That is, it is possible to implement an amorphous alloy soft magnetic powder having an optimum particle size distribution and having a high contribution to the filling properties of the contained small-diameter particles.

When the average circularity is less than the lower limit value, it is difficult to spheroidize the small-diameter particles, and thus the filling properties of the amorphous alloy soft magnetic powder may deteriorate. On the other hand, when the average circularity is more than the above upper limit value, the production difficulty increases, and production efficiency of the amorphous alloy soft magnetic powder may decrease.

The average circularity of the amorphous alloy soft magnetic powder is measured as follows.

First, an image (secondary electron image) of the amorphous alloy soft magnetic powder is captured using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 to 100 particles appear in one image. Then, a plurality of images are acquired to obtain images of a total of 300 or more particles.

Next, a circularity of the images of 300 or more particles is calculated using software, and an average value is obtained. The obtained average value is the average circularity of the amorphous alloy soft magnetic powder. When a circularity is represented by e, an area of a particle image is represented by S, and a perimeter of the particle image is represented by L, the circularity e is obtained using the following formula.

$$e = 4 \prod S / {L}^{2}$$

The coercive force of the amorphous alloy soft magnetic powder is preferably 1.50 Oe or less and (119.4 A/m or less, more preferably 1.20 Oe or less and (95.49 A/m or less, and further preferably 1.00 Oe or less (79.58 A/m or less). By using the amorphous alloy soft magnetic powder having a low coercive force, a magnetic element capable of sufficiently reducing hysteresis loss can be implemented.

When the coercive force is less than the lower limit value, it is difficult to stably produce such an amorphous alloy soft magnetic powder having a low coercive force, and when the low coercive force is pursued too much, the permeability may be adversely affected. On the other hand, when the coercive force is more than the upper limit value, the hysteresis loss is increased, and thus an iron loss of the magnetic element may be increased.

The coercive force of the amorphous alloy soft magnetic powder can be measured by a vibrating sample magnetometer such as TM-VSM1230-MHHL manufactured by Tamakawa Co., Ltd.

The tap density of the amorphous alloy soft magnetic powder is preferably 4.70 g/cm³ or more and 5.20 g/cm³ or less, more preferably 4.75 g/cm³ or more and 5.15 g/cm³ or less, and still more preferably 4.80 g/cm³ or more and 5.10 g/cm³ or less. When the tap density is within the above range, an amorphous alloy soft magnetic powder having a relatively small number of irregularly shaped particles and having excellent fluidity and filling properties is obtained. Such an amorphous alloy soft magnetic powder can produce a high-density dust core, and thus can particularly enhance the saturation magnetic flux density and the permeability of the magnetic element.

When the tap density is less than the lower limit value, when the amorphous alloy soft magnetic powder is compacted to obtain a dust core, the fluidity and the filling properties of the amorphous alloy soft magnetic powder may decrease. On the other hand, when the tap density is more than the upper limit value, production difficulty of the amorphous alloy soft magnetic powder increases, and a production yield may decrease.

The tap density of the amorphous alloy soft magnetic powder is measured according to a metal powder-tap density measurement method specified in JIS Z 2512:2012.

When a dust core is produced using the amorphous alloy soft magnetic powder, the obtained dust core has high DC superimposition characteristics. In general, a DC current is often superimposed on an AC signal and applied to the magnetic element. Therefore, the amorphous alloy soft magnetic powder is required to have good permeability characteristics under a DC magnetic field. In the present specification, when the permeability when the DC bias current is superimposed on the AC signal and applied decreases to 80% which is the permeability when the DC bias current is not applied, the DC bias current at that time is referred to as a DC superimposition characteristic. When the DC superimposition characteristic according to this definition is high, high permeability can be maintained even in a high applied magnetic field, and thus the DC superimposition characteristic can be regarded as good.

The DC superimposition characteristics of the amorphous alloy soft magnetic powder are measured as follows.

First, an epoxy resin in an amount equivalent to 2.0 mass % is mixed with the amorphous alloy soft magnetic powder, and the obtained mixture is press-molded at a pressure of 294.2 MPa (3 t/cm²). Accordingly, a molded product is obtained which is in a shape of a ring having an outer diameter of 28 mm, an inner diameter of 14 mm, a thickness of 5 mm and a relative density of 66%. The relative density is a relative value obtained by dividing the density obtained by dividing a mass of the molded product by a volume by the particle density of the amorphous alloy soft magnetic powder. Next, the obtained molded product is placed in a resin case, and then a conductive wire having a wire diameter of 1.25 mm is wound around the case 50 times to prepare a test object. Next, permeability when an AC signal having a frequency of 10 kHz is applied to the test object without superimposing a DC bias current is set as a reference value. Next, the permeability is measured while gradually increasing the DC bias current superimposed on the test object. For the measurement of the permeability, an impedance analyzer such as the 4194A manufactured by Agilent Technologies, Inc. is used. Further, when a measured value decreases to the reference value of 80%, the DC bias current at that time is recorded, and the value is used as the DC superimposition characteristic.

The DC superimposition characteristics of the amorphous alloy soft magnetic powder are preferably 25 A or more and 30 A or less, and more preferably 25 A or more and 28 A or less. The amorphous alloy soft magnetic powder having such a DC superimposition characteristic is suitable for a high current application. That is, according to the amorphous alloy soft magnetic powder having such a DC superimposition characteristic, it is possible to implement a magnetic element having excellent operational stability even when a high current is applied.

A saturation magnetic flux density Bs of the amorphous alloy soft magnetic powder is preferably 1.30 T or more, and more preferably 1.40 T or more. Accordingly, an amorphous alloy soft magnetic powder capable of producing a magnetic element that is unlikely to be saturated even at a high current is obtained.

The saturation magnetic flux density Bs of the amorphous alloy soft magnetic powder is measured by the following method.

First, a true density p g/cm³ of the amorphous alloy soft magnetic powder is measured by a fully automatic gas displacement densitometer, AccuPyc1330 manufactured by Micromeritics Corporation. A method for measuring the true density p is not limited thereto. Next, a maximum magnetic moment Mm [emu/g] of the amorphous alloy soft magnetic powder is measured by a vibrating sample magnetometer, VSM system manufactured by Tamakawa Co., Ltd., TM-VSM1230-MHHL. Then, the saturation magnetic flux density Bs [T] is calculated by the following formula.

$$Bs = 4 \prod / 10000 \times ρ \times Mm$$

An iron loss of the amorphous alloy soft magnetic powder is preferably 1000 kW/m³ or less, and more preferably 800 kW/m³ or less at a measurement frequency of 1 MHz. Accordingly, an amorphous alloy soft magnetic powder applicable to a power-saving electronic device or the like can be implemented.

The iron loss of the amorphous alloy soft magnetic powder is preferably 5000 kW/m³ or less, and more preferably 4000 kW/m³ or less at a measurement frequency of 3 MHz. Accordingly, an amorphous alloy soft magnetic powder applicable to a power-saving electronic device or the like can be implemented.

A method for measuring the iron loss of the amorphous alloy soft magnetic powder is as follows.

First, an epoxy resin in an amount equivalent to 2.0 mass % of the amorphous alloy soft magnetic powder is mixed with the amorphous alloy soft magnetic powder, and the obtained mixture is press-molded at a pressure of 49.0 MPa (0.5 t/cm²). Accordingly, a ring-shaped green compact having an outer diameter of 14 mm, an inner diameter of 8 mm, and a thickness of 3 mm is obtained. Next, a conductive wire having a wire diameter of 0.16 mm is wound around the obtained green compact in 18 turns on a primary side and 18 turns on a secondary side to obtain a test object. A constituent material of the conductive wire is Cu. Next, the iron loss of the obtained test object is measured. An iron loss measurement device is a BH analyzer SY-8218 manufactured by Iwasaki Electric Co., Ltd., an iron loss measurement frequency is 1 MHz or 3 MHz, and a maximum magnetic flux density during iron loss measurement is 20 mT.

### 2. Method for Producing Amorphous Alloy Soft Magnetic Powder

Next, a method for producing the amorphous alloy soft magnetic powder according to the embodiment will be described.

The amorphous alloy soft magnetic powder according to the embodiment may be produced by any production method, for example, various powderization methods such as an atomization method, a reduction method, a carbonyl method, and a pulverization method.

The atomization method is a method for producing a powder by pulverizing a molten raw material and cooling it at the same time by colliding it with a fluid such as a liquid or a gas ejected at a high speed. Examples of the atomization method include a water atomization method, a gas atomization method, and a rotary water jet atomization method, depending on a difference in a type of a cooling medium and a device configuration. Among these, the amorphous alloy soft magnetic powder is preferably produced by the water atomization method or the rotary water jet atomization method, and more preferably produced by the rotary water jet atomization method.

Among these, the “water atomization method” in the present specification refers to a method for producing a metal powder by using a liquid such as water or oil as a coolant, ejecting it in an inverted conical shape that converges to one point, and then allowing a molten metal to flow down toward the convergence point and collide with liquid.

On the other hand, according to the rotary water jet atomization method, since the molten metal can be cooled at an extremely high speed using a rotary water jet, it is particularly easy to make the molten metal amorphous.

When the amorphous alloy soft magnetic powder is produced, a cooling rate of the molten metal is preferably more than 10⁶ K/sec, and more preferably 107 K/sec or more. Accordingly, an amorphous alloy soft magnetic powder in which amorphization is sufficiently achieved is obtained. That is, amorphization can be achieved even in a composition having a relatively high content of Fe. In particular, according to the rotary water jet atomization method, a cooling rate of more than 10⁶ K/sec can be easily achieved.

Hereinafter, the method for producing the amorphous alloy soft magnetic powder by the rotary water jet atomization method will be further described.

In the rotary water jet atomization method, a coolant is injected and supplied along an inner circumferential surface of a cooling tubular body and swirled along the inner circumferential surface of the cooling tubular body to form a coolant layer at the inner circumferential surface. On the other hand, a raw material of the amorphous alloy soft magnetic powder is melted, and while the obtained molten metal is naturally dropped, a liquid or gas jet is sprayed to the molten metal. When the molten metal is scattered in this manner, the scattered molten metal is taken into the coolant layer. As a result, the scattered and pulverized molten metal is rapidly cooled and solidified to obtain an amorphous alloy soft magnetic powder.

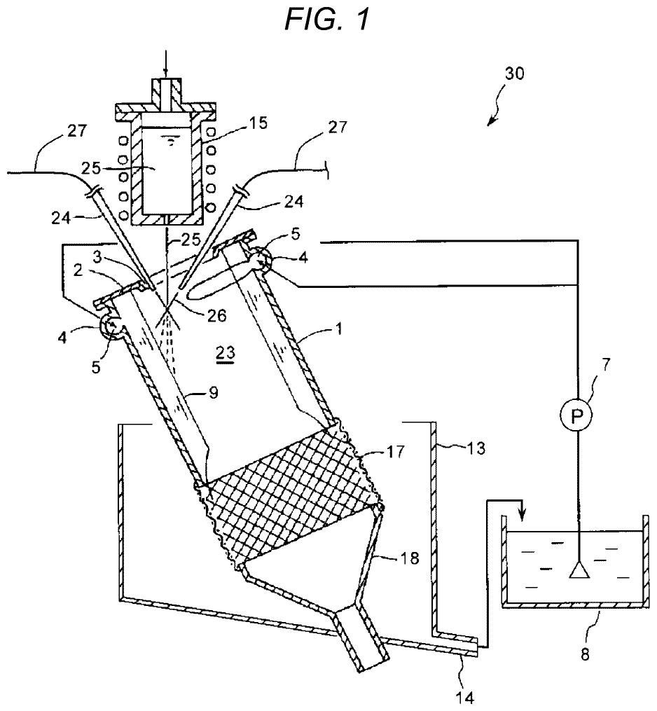

FIG. 1 is a longitudinal cross-sectional view showing an example of a device for producing the amorphous alloy soft magnetic powder by the rotary water jet atomization method.

A powder production device 30 shown in FIG. 1 includes a cooling tubular body 1, a crucible 15, a pump 7, and a jet nozzle 24. The cooling tubular body 1 is a tubular body for forming a coolant layer 9 at an inner circumferential surface of the cooling tubular body 1. The crucible 15 is a supply container for causing a molten metal 25 to flow down and for supplying the molten metal 25 to a space portion 23 inside the coolant layer 9. The pump 7 supplies a coolant to the cooling tubular body 1. The jet nozzle 24 injects a gas jet 26 that divides the flowing minute flow molten metal 25 into liquid droplets. The molten metal 25 is prepared according to the composition of the amorphous alloy soft magnetic powder.

The cooling tubular body 1 has a cylindrical shape, and is provided such that a tubular body axis line extends along a vertical direction or is inclined at an angle of 30° or less with respect to the vertical direction.

An upper end opening of the cooling tubular body 1 is closed by a lid body 2. An opening 3 for supplying the molten metal 25 flowing down to the space portion 23 of the cooling tubular body 1 is formed in the lid body 2.

A coolant injecting pipe 4 for injecting the coolant to the inner circumferential surface of the cooling tubular body 1 is provided in an upper portion of the cooling tubular body 1. A plurality of dispensing ports 5 of the coolant injecting pipes 4 are provided at equal intervals along a circumferential direction of the cooling tubular body 1.

The coolant injecting pipe 4 is coupled to a tank 8 via pipes to which the pump 7 is coupled, and the coolant in the tank 8 sucked up by the pump 7 is injected and supplied via the coolant injecting pipe 4 into the cooling tubular body 1. Accordingly, the coolant gradually flows down while rotating along the inner circumferential surface of the cooling tubular body 1, and accordingly, the coolant layer 9 along the inner circumferential surface is formed. A cooler may be interposed as necessary in the tank 8 or in a middle of a circulation flow path. As the coolant, in addition to water, oil such as silicone oil is used, and various additives may be further added. Further, by removing dissolved oxygen in the coolant in advance, oxidation of the powder to be produced can be prevented.

A liquid draining net body 17 having a cylindrical shape is continuously provided on a lower portion of the cooling tubular body 1, and on the lower side of the liquid draining net body 17, a funnel-shaped powder recovery container 18 is provided. A coolant recovery cover 13 is provided around the liquid draining net body 17 to cover the liquid draining net body 17, and a drain port 14 formed in a bottom portion of the coolant recovery cover 13 is coupled via a pipe to the tank 8.

The jet nozzle 24 is provided in the space portion 23. The jet nozzle 24 is attached to a tip end of a gas supply pipe 27 and is inserted through the opening 3 of the lid body 2 into the cooling tubular body 1, and an injection port of the jet nozzle 24 is directed to the molten metal 25 in the form of a minute flow.

In order to produce the amorphous alloy soft magnetic powder by such the powder production device 30, first, the pump 7 is operated to form the coolant layer 9 at the inner circumferential surface of the cooling tubular body 1. Next, the molten metal 25 in the crucible 15 is caused to flow down into the space portion 23. When the gas jet 26 is sprayed to the molten metal 25 flowing down, the molten metal 25 is scattered, and the pulverized molten metal 25 is caught in the coolant layer 9. As a result, the pulverized molten metal 25 is cooled and solidified, and the amorphous alloy soft magnetic powder is obtained.

In the rotary water jet atomization method, a fairly high cooling rate can be stably maintained by continuously supplying the coolant, which promotes the amorphization of the produced amorphous alloy soft magnetic powder.

Since the molten metal 25 refined to a certain size by the gas jet 26 falls by inertia until the molten metal 25 is caught in the coolant layer 9, liquid droplets are made spherical at this time.

The temperature (casting temperature) of the molten metal 25 may be equal to or higher than the melting point of the raw material, and is preferably higher than the melting point of the raw material by 200° C. or higher and 400° C. or lower, more preferably by 230° C. or higher and 370° C. or lower, and still more preferably by 250° C. or higher and 350° C. or lower. Accordingly, the viscosity of the molten metal 25 is optimized, and an amorphous alloy soft magnetic powder in which the particle size distribution, the number ratio of the hollow particles, the average circularity, and the particle density are optimized can be produced.

When the temperature of the molten metal 25 is lower than the lower limit value, the viscosity of the molten metal 25 increases, and thus, for example, the number ratio or the average circularity of the hollow particles may deviate from the above range. On the other hand, when the temperature of the molten metal 25 is more than the upper limit value, special heat resistance is required in the crucible 15, and thus it may be difficult to stably hold the molten metal 25.

The prepared molten metal 25 is dispensed through the dispensing port of the crucible 15 and supplied to the cooling tubular body 1. The inner diameter (nozzle diameter) of the dispensing port of the crucible 15 determines the particle diameter of the molten metal 25 flowing down, and affects a production amount, a particle diameter, sphericity, and the like of the amorphous alloy soft magnetic powder per unit time. An inner diameter of the dispensing port of the crucible 15 is preferably 1.5 mm or more and 6.0 mm or less, more preferably 2.0 mm or more and 5.5 mm or less, and still more preferably 2.5 mm or more and 4.0 mm or less. When the inner diameter of the dispensing port of the crucible 15 is within the above range, an amorphous alloy soft magnetic powder in which the particle size distribution, the number ratio of the hollow particles, the average circularity, the particle density, and the like are optimized can be produced.

A flow-down amount of the molten metal 25 flowing down from the crucible 15 varies depending on a device size and the like, and is preferably more than 1.0 kg/min and 20.0 kg/min or less, and more preferably 2.0 kg/min or more and 10.0 kg/min or less. Accordingly, since the amount of the molten metal 25 flowing down in a certain time can be optimized, an amorphous alloy soft magnetic powder in which the particle size distribution, the number ratio of the hollow particles, the average circularity, the particle density, and the like are optimized can be produced.

A pressure of the gas jet 26 slightly varies depending on the configuration of the jet nozzle 24, and is preferably 2.0 MPa or more and 20.0 MPa or less, and more preferably 3.0 MPa or more and 10.0 MPa or less. Accordingly, it is possible to produce an amorphous alloy soft magnetic powder in which the particle size distribution, the number ratio of the hollow particles, the average circularity, the particle density, and the like are optimized by optimizing the particle diameter when the molten metal 25 is scattered.

When the pressure of the gas jet 26 is less than the lower limit value, it is difficult to sufficiently finely scatter the gas jet 26, and the particle diameter increases while the cooling rate inside the liquid droplets decreases, which may result in insufficient amorphization. In addition, the number ratio of the hollow particles may decrease or the particle density may increase. On the other hand, when the pressure of the gas jet 26 is more than the upper limit value, the particle diameter of the liquid droplets after the scattering may be too small. Then, the liquid droplets are gradually cooled by the gas jet 26, and rapid cooling by the coolant layer 9 cannot be performed, so that amorphization may be insufficient. In addition, the number ratio of the hollow particles may increase or the particle density may decrease.

The flow rate of the gas jet 26 is not particularly limited, and is preferably 1.0 Nm³/min or more and 20.0 Nm³/min or less, and more preferably 4.0 Nm³/min or more and 10.0 Nm³/min or less. Accordingly, it is possible to produce an amorphous alloy soft magnetic powder in which the particle size distribution, the number ratio of the hollow particles, the average circularity, the particle density, and the like are optimized by optimizing the particle diameter when the molten metal 25 is scattered.

When the flow rate of the gas jet 26 is less than the lower limit value, it is difficult to sufficiently finely scatter the gas jet 26, and the particle diameter increases while the cooling rate inside the liquid droplets decreases, which may result in insufficient amorphization. In addition, the number ratio of the hollow particles may decrease or the particle density may increase. On the other hand, when the flow rate of the gas jet 26 is more than the upper limit value, the particle diameter of the liquid droplets after the scattering may be too small. Then, the liquid droplets are gradually cooled by the gas jet 26, and rapid cooling by the coolant layer 9 cannot be performed, so that amorphization may be insufficient. In addition, the number ratio of the hollow particles may increase or the particle density may decrease.

The pressure during injection of the coolant supplied to the cooling tubular body 1 is preferably about 5 MPa or more and 200 MPa or less, more preferably about 20 MPa or more and 100 MPa or less, and further preferably 50 MPa or more and 100 MPa or less. Accordingly, a flow velocity of the coolant layer 9 is optimized, and the pulverized molten metal 25 is less likely to have an irregular shape. As a result, an amorphous alloy soft magnetic powder having more excellent filling properties is obtained. In addition, the cooling rate of the molten metal 25 by the coolant can be sufficiently enhanced. As described above, the amorphous alloy soft magnetic powder is obtained.

The amorphous alloy soft magnetic powder may be subjected to a classification process as necessary. Examples of the classification process include dry classification such as sieving classification, inertial classification, centrifugal classification, and air classification, and wet classification such as sedimentation classification.

If necessary, an insulating film may be formed at a surface of each particle of the obtained amorphous alloy soft magnetic powder. A constituent material of the insulating film is not particularly limited, and examples thereof include inorganic materials such as a phosphate such as magnesium phosphate, calcium phosphate, zinc phosphate, manganese phosphate, and cadmium phosphate, and a silicate such as sodium silicate.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, a solenoid valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is the magnetic element according to the embodiment, will be described.

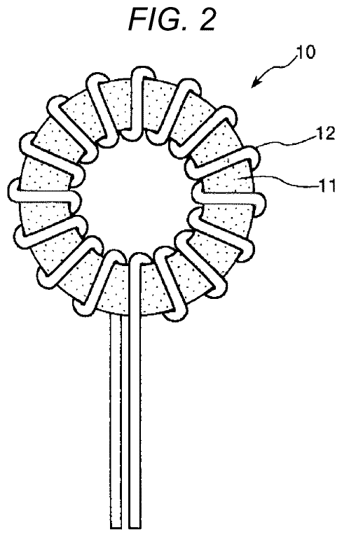

FIG. 2 is a plan view schematically showing a toroidal type coil component. A coil component 10 shown in FIG. 2 includes a ring-shaped dust core 11 and a conductive wire 12 wound around the dust core 11.

The dust core 11 is obtained by mixing the amorphous alloy soft magnetic powder described above and a binder, supplying the obtained mixture to a mold, and pressurizing and molding. That is, the dust core 11 is a green compact containing the amorphous alloy soft magnetic powder according to the embodiment. The coil component 10 including such the dust core 11 has a low iron loss, a high density, and good DC superimposition characteristics. Therefore, when the coil component 10 is mounted on an electronic device or the like, power consumption of the electronic device or the like can be reduced, and the electronic device can be reduced in size and increased in output.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating film is provided on a surface of the conductive wire 12 as necessary.

A shape of the dust core 11 is not limited to the ring shape shown in FIG. 2, and may be, for example, a shape in which a part of the ring is missing, or a shape in which a shape in a longitudinal direction is linear.

The dust core 11 may contain, as necessary, a soft magnetic powder other than the amorphous alloy soft magnetic powder according to the embodiment, or a non-magnetic powder.

### 3.2. Closed Magnetic Circuit Type

Next, a closed magnetic circuit type coil component, which is the magnetic element according to the embodiment, will be described.

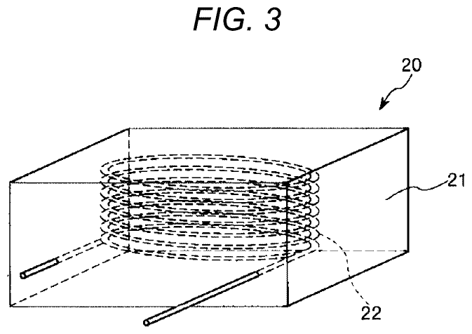

FIG. 3 is a transparent perspective view schematically showing the closed magnetic circuit type coil component.

Hereinafter, the closed magnetic circuit type coil component will be described. In the following description, differences from the toroidal type coil component will mainly be described, and description of similar matters will be omitted.

A coil component 20 shown in FIG. 3 includes a dust core 21 having a chip shape and a conductive wire 22 embedded in the dust core 21 and formed into a coil shape. That is, the dust core 21 is a green compact containing the amorphous alloy soft magnetic powder according to the embodiment. The coil component 20 including such the dust core 21 has a low iron loss, a high density, and good DC superimposition characteristics. Therefore, the coil component 20 contributes to power saving, miniaturization, and high output of the electronic device.

The dust core 21 may contain, as necessary, a soft magnetic powder other than the amorphous alloy soft magnetic powder according to the embodiment, or a non-magnetic powder.

### 4. Electronic Device

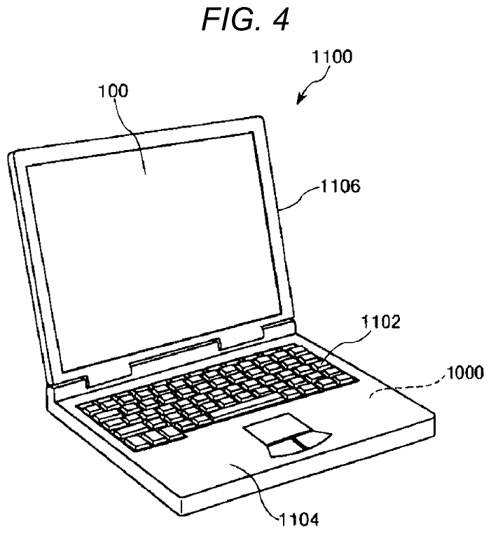

Next, an electronic device according to the embodiment will be described with reference to FIGS. 4 to 6.

FIG. 4 is a perspective view showing a mobile personal computer 1100 which is the electronic device according to the embodiment. The personal computer 1100 shown in FIG. 4 includes a main body 1104 including a keyboard 1102 and a display unit 1106 including a display 100. The display unit 1106 is pivotally supported by the main body 1104 via a hinge structure. Such a personal computer 1100 includes therein a magnetic element 1000 such as a choke coil, an inductor, or a motor for a switching power supply.

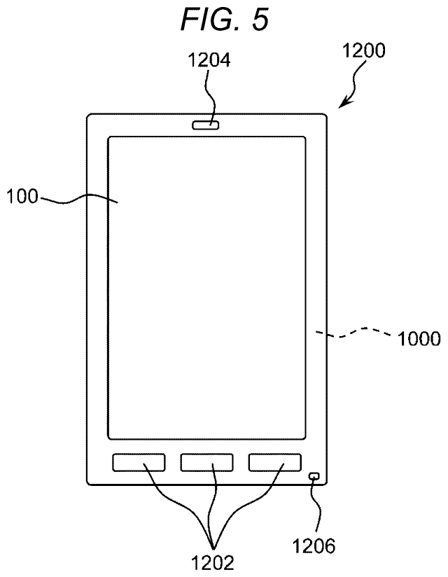

FIG. 5 is a plan view showing a smartphone 1200 which is the electronic device according to the embodiment. The smartphone 1200 shown in FIG. 5 includes a plurality of operation buttons 1202, an earpiece 1204, and a mouthpiece 1206. The display 100 is disposed between the operation buttons 1202 and the earpiece 1204. Such the smartphone 1200 includes therein the magnetic element 1000 such as an inductor, a noise filter, or a motor.

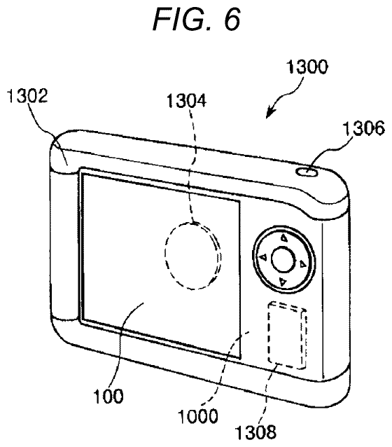

FIG. 6 is a perspective view showing a digital still camera 1300 which is the electronic device according to the embodiment. The digital still camera 1300 photoelectrically converts an optical image of a subject with an imaging element such as a charge coupled device (CCD) to generate an imaging signal.

The digital still camera 1300 shown in FIG. 6 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such the digital still camera 1300 also includes therein the magnetic element 1000 such as an inductor or a noise filter.

Such an electronic device includes the magnetic element according to the embodiment. Accordingly, the effect of the magnetic element, such as a low iron loss, a high density, and good DC superimposition characteristics, can be obtained, and miniaturization and high performance of the electronic device can be achieved.

Examples of the electronic device according to the embodiment include, in addition to the personal computer in FIG. 4, the smartphone in FIG. 5, and the digital still camera in FIG. 6, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

### 5. Effects of Embodiment

As described above, the amorphous alloy soft magnetic powder according to the embodiment includes: impurities; and a composition represented by a composition formula Feₐ(Si₁₋ₓBₓ)_{b}C_{c}S_{d} represented by an atomic ratio, where a is 100−b−c−d, and b, c, d, and x are 16.0≤b≤22.0, 0<c≤4.0, 0.001≤d≤0.080, and 0.5≤x≤0.9. In a volume-based cumulative particle size distribution obtained using a laser diffraction type particle size distribution measurement device, when D50 is a particle diameter at which a cumulative frequency is 50% from a small diameter side, the particle diameter D50 is 22.0 μm or more and 32.0 μm or less, hollow particles are contained, and a number ratio of the hollow particles is 3% or more and 22% or less.

According to such a configuration, it is possible to implement an amorphous alloy soft magnetic powder capable of producing a magnetic element having a low iron loss, a high density, and good DC superimposition characteristics.

In the amorphous alloy soft magnetic powder according to the embodiment, it is preferable that, when the amorphous alloy soft magnetic powder is mixed with an epoxy resin having a mass ratio of 2.0 mass %, an obtained mixture is press-molded at a pressure of 294.2 MPa, which is 3 t/cm², to prepare a ring-shaped molded product having an outer diameter of 28 mm, an inner diameter of 14 mm, and a thickness of 5 mm, then a conductive wire having a wire diameter of 1.25 mm is wound around the molded product 50 times to prepare a test object, permeability when an AC signal having a frequency of 10 kHz is applied to the test object without superimposing a DC bias current is set as a reference value, and permeability measured while gradually increasing the DC bias current superimposed on the AC signal decreases to 80% of the reference value, a value of the DC bias current is 25 A or more and 30 A or less.

According to such a configuration, an amorphous alloy soft magnetic powder suitable for a high current application is obtained. That is, according to the amorphous alloy soft magnetic powder having such a DC superimposition characteristic, it is possible to implement a magnetic element having excellent operational stability even when a high current is applied.

In the amorphous alloy soft magnetic powder according to the embodiment, a particle density is preferably 7.05 g/cm³ or more and 7.18 g/cm³ or less.

According to such a configuration, a volume of the hollow portion in the hollow particle can be optimized. Accordingly, in the magnetic element including the amorphous alloy soft magnetic powder, both low iron loss, high density, and excellent DC superimposition characteristics can be achieved.

In the amorphous alloy soft magnetic powder according to the embodiment, an average circularity of the particles is preferably 0.85 or more and less than 1.00.

According to such a configuration, the filling state of the amorphous alloy soft magnetic powder can be brought close to closest packing. That is, it is possible to implement an amorphous alloy soft magnetic powder having an optimum particle size distribution and having a high contribution to the filling properties of the contained small-diameter particles.

In the amorphous alloy soft magnetic powder according to the embodiment, the tap density is preferably 4.70 g/cm³ or more and 5.20 g/cm³ or less.

According to such a configuration, an amorphous alloy soft magnetic powder having a relatively small number of irregularly shaped particles and having excellent fluidity and filling properties is obtained. Such an amorphous alloy soft magnetic powder can produce a high-density dust core, and thus can particularly enhance the saturation magnetic flux density and the permeability of the magnetic element.

In the amorphous alloy soft magnetic powder according to the embodiment, a coercive force is preferably 1.50 Oe or less (119.4 A/m or less).

According to such a configuration, a magnetic element having a sufficiently low hysteresis loss can be implemented.

In the amorphous alloy soft magnetic powder according to the embodiment, in the cumulative particle size distribution, when D10 is a particle diameter at which the cumulative frequency is 10% from the small diameter side, D90 is a particle diameter at which the cumulative frequency is 90% from the small diameter side and a ratio of the particle diameter D10 to the particle diameter D90 is a particle diameter ratio D10/D90, the particle diameter ratio D10/D90 is preferably 0.210 or more and 0.225 or less.

According to such a configuration, the filling properties of the amorphous alloy soft magnetic powder become particularly good.

A dust core according to the embodiment includes the amorphous alloy soft magnetic powder according to the embodiment.

According to such a configuration, it is possible to obtain a dust core capable of producing a magnetic element having a low iron loss, a high density, and good DC superimposition characteristics.

A magnetic element according to the embodiment includes the dust core according to the embodiment.

According to such a configuration, it is possible to obtain a magnetic element having a low iron loss, a high density, and good DC superimposition characteristics.

An electronic device according to the embodiment includes the magnetic element according to the embodiment.

According to such a configuration, it is possible to obtain an electronic device whose miniaturization and high performance are achieved.

The amorphous alloy soft magnetic powder, the dust core, the magnetic element, and the electronic device of the present disclosure are described above based on the preferred embodiment, and the present disclosure is not limited thereto. For example, the dust core and the magnetic element according to the present disclosure may be what is obtained by replacing each unit of the embodiment described above with any component having the same function, or what is obtained by adding any constituent to the embodiment described above.

In addition, in the above embodiment, a dust core is described as an example of an application of the amorphous alloy soft magnetic powder of the present disclosure, and the application example is not limited thereto, and may be, for example, a magnetic fluid, a magnetic shielding sheet, and a magnetic device such as a magnetic head. In addition, shapes of the dust core and the magnetic element are not limited to those shown in the drawings, and any shapes may be adopted.

### EXAMPLES

Next, specific examples of the present disclosure will be described.

### 6. Production of Amorphous Alloy Soft Magnetic Powder

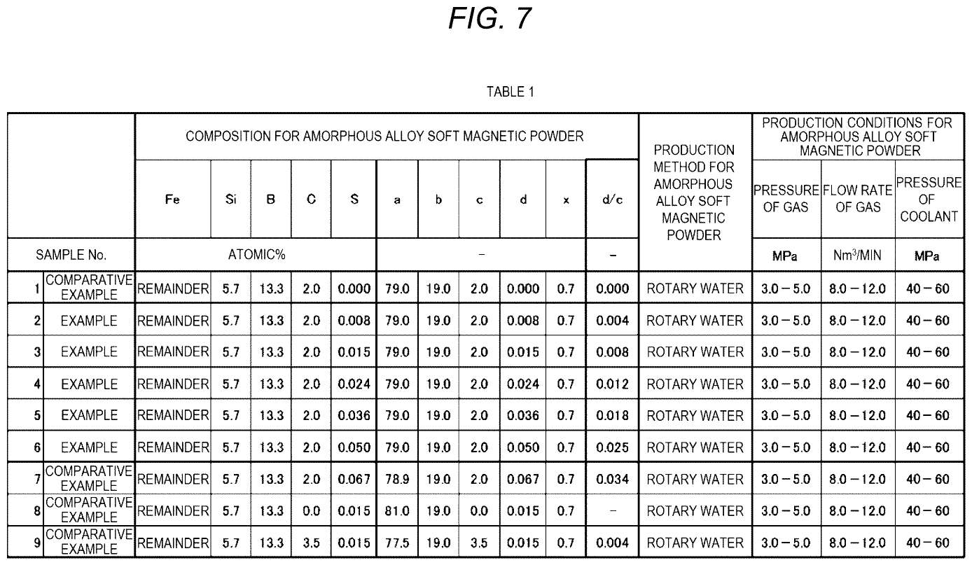

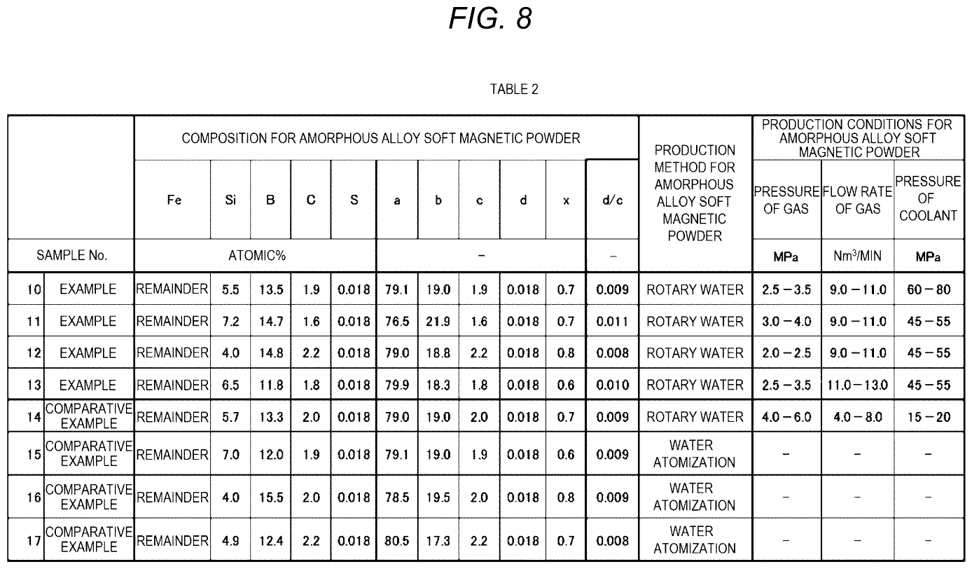

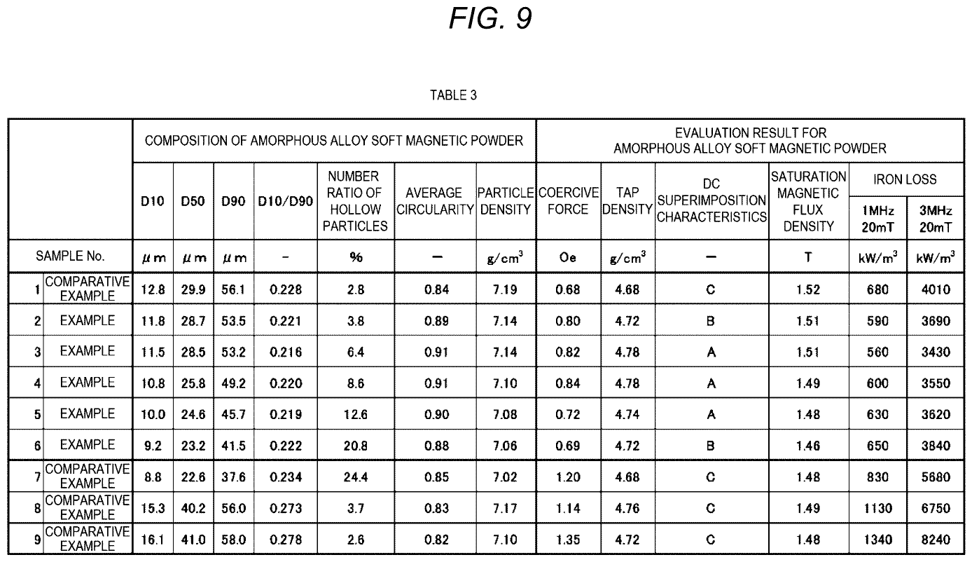

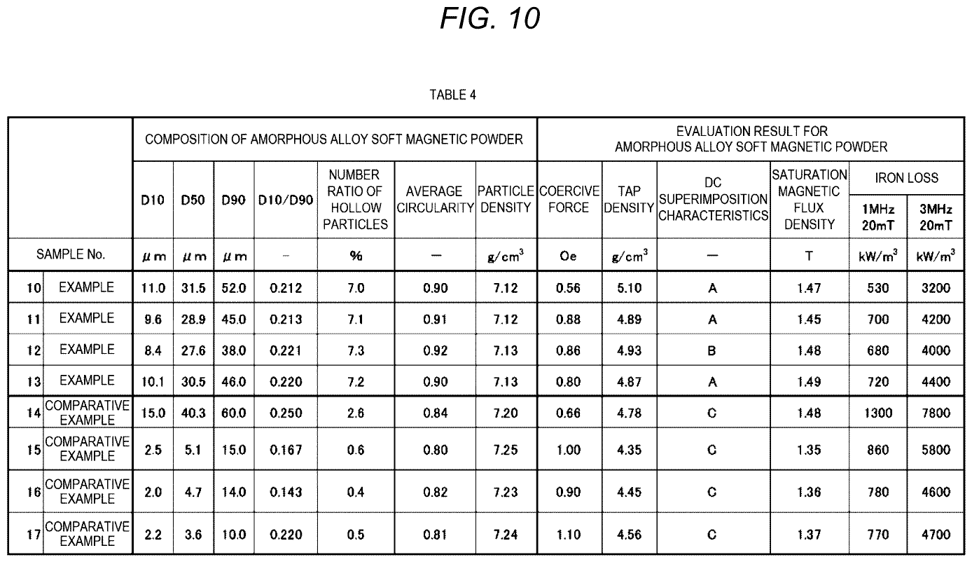

FIG. 7 is Table 1 showing the composition and the like of the amorphous alloy soft magnetic powders of sample Nos. 1 to 9. FIG. 8 is Table 2 showing the composition and the like of the amorphous alloy soft magnetic powders of sample Nos. 10 to 17. FIG. 9 is Table 3 showing evaluation results and the like of the amorphous alloy soft magnetic powders of sample Nos. 1 to 9. FIG. 10 is Table 4 showing the evaluation results and the like of the amorphous alloy soft magnetic powders of sample Nos. 10 to 17.

### 6.1. Sample No. 1

First, a raw material was melted in a high-frequency induction furnace and pulverized by a rotary water jet atomization method to obtain a metal powder formed by an amorphous alloy. A pressure of the gas jet was 3.0 MPa to 5.0 MPa, a flow rate of the gas jet was 8.0 Nm³/min to 12.0 Nm³/min, and a pressure of the coolant was 40 MPa to 60 MPa.

Next, the obtained metal powder was subjected to a heat treatment. A heating temperature of the heat treatment was 410° C., a time for holding the heating temperature (heating time) was 15 minutes, and a furnace atmosphere was a nitrogen atmosphere.

Next, classification was performed by a classifier using a mesh having an opening of 53 μm. The classified metal powder was recovered as an amorphous alloy soft magnetic powder. The composition of the recovered amorphous alloy soft magnetic powder is shown in Table 1. The composition was determined using a solid-state optical emission spectrometer manufactured by SPECTRO, model: SPECTROLAB, type: LAVMB08A.

### 6.2. Sample Nos. 2 to 14

An amorphous alloy soft magnetic powder was obtained in the same manner as in the case of Sample No. 1 except that the composition, the production method, and the production conditions of the amorphous alloy soft magnetic powder were changed as shown in Table 1 (FIG. 7) or Table 2 (FIG. 8).

In the production of the amorphous alloy soft magnetic powders of Sample Nos. 1 to 14, the temperature of the molten metal (casting temperature) was set to +250° C. to +350° C. with respect to the melting point of the raw material, and an inner diameter of the dispensing port of the crucible was set to 2.5 mm to 3.5 mm.

### 6.3. Sample Nos. 15 to 17

An amorphous alloy soft magnetic powder was obtained in the same manner as in the case of Sample No. 1 except that the method for producing the amorphous alloy soft magnetic powder was changed to the water atomization method, and the composition, the production method, and the production conditions of the amorphous alloy soft magnetic powder were changed to those shown in Table 2.

In the production of the amorphous alloy soft magnetic powder of sample Nos. 15 to 17, the temperature of the molten metal (casting temperature) was set to +150° C. to +250° C. with respect to the melting point of the raw material, and the inner diameter of the dispensing port of the crucible was set to 1.5 mm to 2.5 mm.

In Tables 1 to 4, among the amorphous alloy soft magnetic powders of the respective sample numbers, those corresponding to the present disclosure are classified as “Example”, and those not corresponding to the present disclosure are classified as “Comparative Example”. 7. Evaluation for Amorphous Alloy Soft Magnetic Powder

### 7.1. Powder Properties

The amorphous alloy soft magnetic powder obtained in each of the Examples and Comparative Examples was subjected to particle size distribution measurement. The measurement was carried out using a laser diffraction type particle size distribution measurement device, Microtrac HRA9320-X100 manufactured by Nikkiso Co., Ltd. Then, a particle diameter D10, a particle diameter D50, a particle diameter D90, and a particle diameter ratio D10/D90 were calculated. Calculation results are shown in Table 3 (FIG. 9) and Table 4 (FIG. 10).

### 7.2. Number Ratio of Hollow Particles

For the amorphous alloy soft magnetic powder of each of Examples and Comparative Examples, the number of hollow particles was counted, and the number ratio of the hollow particles was calculated. The calculation results are shown in Tables 3 and 4.

### 7.3. Average Circularity

The average circularity of the particles of the amorphous alloy soft magnetic powder in each of the Examples and Comparative Examples was calculated. The calculation results are shown in Tables 3 and 4.

### 7.4. Particle Density

The particle density of the amorphous alloy soft magnetic powder in each of the Examples and Comparative Examples was measured. The measurement results are shown in Tables 3 and 4.

### 7.5. Coercive Force

The coercive force of the amorphous alloy soft magnetic powder in each of the Examples and Comparative Examples was measured. The measurement results are shown in Tables 3 and 4.

### 7.6. Tap Density

The tap density of the amorphous alloy soft magnetic powder in each of the Examples and Comparative Examples was measured. The measurement results are shown in Tables 3 and 4.

### 7.7. DC Superimposition Characteristics

The DC superimposition characteristics of the amorphous alloy soft magnetic powders in each of the Examples and Comparative Examples were measured. Then, the measurement results were evaluated according to the following evaluation criteria. Evaluation results are shown in Tables 3 and 4.
A: 25 A or more
B: 23 A or more and less than 25 A
C: less than 23 A

### 7.8. Saturation Magnetic Flux Density

The saturation magnetic flux density of the amorphous alloy soft magnetic powder in each of the Examples and Comparative Examples was measured. The measurement results are shown in Tables 3 and 4.

### 7.9. Iron Loss

The iron loss of the amorphous alloy soft magnetic powders in each of the Examples and Comparative Examples was measured at measurement frequencies of 1 MHz and 3 MHz. The measurement results are shown in Tables 3 and 4.

As is clear from Tables 3 and 4, it is found that the amorphous alloy soft magnetic powder of each of Examples has a low iron loss, a high density, and good DC superimposition characteristics as compared with the amorphous alloy soft magnetic powder of each of Comparative Examples.

What is claimed is:

1. An amorphous alloy soft magnetic powder comprising:
impurities; and
a composition represented by a composition formula Feₐ(Si₁₋ₓBₓ)_{b}C_{c}S_{d} represented by an atomic ratio, where a is 100−b−c−d, and b, c, d, and x are 16.0≤b≤22.0, 0<c≤4.0, 0.001≤d≤0.080, and 0.5≤x≤0.9, wherein
in a volume-based cumulative particle size distribution obtained using a laser diffraction type particle size distribution measurement device, when D50 is a particle diameter at which a cumulative frequency is 50% from a small diameter side, the particle diameter D50 is 22.0 μm or more and 32.0 μm or less,
hollow particles are contained, and
a number ratio of the hollow particles is 3% or more and 22% or less.

2. The amorphous alloy soft magnetic powder according to claim 1, wherein
when the amorphous alloy soft magnetic powder is mixed with an epoxy resin having a mass ratio of 2.0 mass %, an obtained mixture is press-molded at a pressure of 294.2 MPa, which is 3 t/cm², to prepare a ring-shaped molded product having an outer diameter of 28 mm, an inner diameter of 14 mm, and a thickness of 5 mm, then a conductive wire having a wire diameter of 1.25 mm is wound around the molded product 50 times to prepare a test object, permeability when an AC signal having a frequency of 10 kHz is applied to the test object without superimposing a DC bias current is set as a reference value, and permeability measured while gradually increasing the DC bias current superimposed on the AC signal decreases to 80% of the reference value, a value of the DC bias current is 25 A or more and 30 A or less.

3. The amorphous alloy soft magnetic powder according to claim 1, wherein
a particle density is 7.05 g/cm³ or more and 7.18 g/cm³ or less.

4. The amorphous alloy soft magnetic powder according to claim 1, wherein
an average circularity of particles is 0.85 or more and less than 1.00.

5. The amorphous alloy soft magnetic powder according to claim 1, wherein
a tap density is 4.70 g/cm³ or more and 5.20 g/cm³ or less.

6. The amorphous alloy soft magnetic powder according to claim 1, wherein
a coercive force is 1.50 Oe or less, which corresponds to 119.4 A/m or less.

7. The amorphous alloy soft magnetic powder according to claim 1, wherein
in the cumulative particle size distribution, when D10 is a particle diameter at which the cumulative frequency is 10% from the small diameter side, D90 is a particle diameter at which the cumulative frequency is 90% from the small diameter side, and a ratio of the particle diameter D10 to the particle diameter D90 is defined as a particle diameter ratio D10/D90, the particle diameter ratio D10/D90 is 0.210 or more and 0.225 or less.

8. A dust core comprising:
the amorphous alloy soft magnetic powder according to claim 1.

9. A magnetic element comprising:
the dust core according to claim 8.

10. An electronic device comprising:
the magnetic element according to claim 9.
